(19) United States
(12) Patent Application Publication
(10) Pub. No.: US 2009/0113557 A1
(43) Pub. Date: Apr. 30, 2009

(54) Different permissions for a control point in a media provision entity

(76) Inventors: Maarten Peter Bodlaender, Eindhoven (NL); Hugo Wilhelmus Jacobus Zonneveld, Zeist (NL)

Correspondence Address: PHILIPS INTELLECTUAL PROPERTY & STANDARDS, P.O. BOX 3001, BRIARCLIFF MANOR, NY, 10510, US

(21) Appl. No.: 10/578,068

(22) PCT Filed: Nov. 2, 2004
(86) PCT No.: PCT/IB04/52255

§ 371 Date: May 2, 2006

(30) Foreign Application Priority Data
Nov. 5, 2003 (EP) 03104088.4

(51) Int. Cl. G06F 21/00

(52) U.S. Cl. 726/27

(57) ABSTRACT

The present invention relates to a method, apparatus, computer program product and computer program element for enabling differentiated control point access to services provided in a computing environment, a method, computer program product and computer program element for providing access to a control point from a media provision entity in a computing environment and a network of computing apparatuses. A media provision entity (12) in the network comprises at least one logical device (24, 26) that provides at least two different sets of permissions in relation to assets (36) associated with the entity. A security console (22) registers a control point (20) in or for the at least one logical device in order to provide access for the control point to the apparatus for rendering services. In this way control points can receive different rights on an asset-by-asset basis without changing the connectivity model used in the network.

The present invention generally relates to the field of security in computer networking. The present invention more particularly relates to a method, apparatus, computer program product and computer program element for enabling differentiated control point access to services provided in a computing environment and a method, computer program product and computer program element for providing access to a control point from a media provision entity in a computing environment as well as to a network of computing apparatuses.

In the field of computer networking the connectivity model used is often UPnP (Universal Plug and Play). This standard defines entities such as control points, devices and security consoles. A device is here a logical entity that has a set of services it offers to different elements of the network, where a security console determines the rights for such elements regarding such a device. A control point can then be allowed to use the services of the device in case the security console has granted the control point access rights. In this environment a control point can be provided in the same or in a different physical entity as the device is provided in. The same applies for the security console, which can be provided in the same entity as the physical device. It can also be provided for different devices. These types of entities are described in more detail in “Home Network Security” by Carl M. Ellison, Intel Technical Journal, Vol. 6, Issue 4, page 37-48, Nov. 15, 2002.

In order to view assets and define rights in relation to these assets a device can furthermore include a content directory service. This service allows browsing and searching of assets of a device for a control point. A Content Directory Service (CDS) is described in more detail in “High-Quality Media Distribution in a Digital Home” by Yasser Rasheed and John Ritchie, Intel Technical Journal, Vol. 6, Issue 4, page 17-29, Nov. 15, 2002.

There is however a problem associated with these known devices and that is that they do not easily provide differentiated views and control of assets on an asset-by-asset basis. An owner of the assets might want to give differentiated services at an asset-by-asset basis to different control points. This means that a control point can have certain security restrictions decided by a security console, like for instance only provide reading rights or providing no rights at all. UPnP presents two facilities to present such rights. Reading/writing rights can be specified using mechanisms specified in the UpnP CDS. However, these mechanisms are then common to all control points, as the CDS has no notion of control point identity. A second facility is offered by the UPnP security mechanism, where access to UPnP CDS functions can be limited according to the individual permissions of control points. However, this access control mechanism is then common for all assets that are offered by the UPnP CDS, as all assets are accessed through the same set of CDS actions. The owner of the assets might want to provide differentiated rights to control points on an asset-by-asset level. This means that a control point might have some rights to a certain asset and some other rights in relation to another asset. It might as an example be desirable to let a control point browse and search only some assets and have limited access to these, while some other assets should not even be browsable and searchable. At the same time it might be desirable to let another control point have full access to all assets. This is not possible in the current UPnP environment.

There is therefore a need for a solution that enables giving control points different rights in relation to assets provided by a media provision entity on an asset-by-asset basis without having to change the connectivity model used.

It is an object of the present invention to enable giving control points different rights in relation to assets provided by a media provision entity on an asset-by-asset basis without having to change the connectivity model used.

According to a first aspect of the present invention, this object is achieved by a method of enabling differentiated control point access to services provided by a media provision entity in a computing environment having a computer networking connectivity model, comprising the steps of:
providing at least one logical device for a media provision entity, and
providing at least two different sets of permissions in relation to assets associated with the media provision entity.

According to a second aspect of the invention, this object is also achieved by a method of providing access to a control point from a media provision entity in a computing environment having a computer networking connectivity model, which entity has at least one logical device providing at least two different sets of permissions in relation to assets associated with the media provision entity comprising the steps of:
receiving an access attempt from a control point in all devices,
granting access according to one of the sets of permissions for which the control point has received access, and
allowing access to the assets according to the permissions set.

According to a third aspect of the present invention, this object is also achieved by an apparatus for enabling differentiated control point access to services provided in a computing environment having a computer networking connectivity model and comprising:
a number of assets, and
at least one logical device providing at least two different sets of permissions to control points in relation to assets associated with the apparatus.

According to a fourth aspect of the present invention, the object is also achieved by a network of computing apparatuses using a computer networking connectivity model and comprising:
at least one control point provided in or for one of the apparatuses of the network,
an apparatus for enabling differentiated control point access to services and comprising:
   at least one logical device providing at least two different sets of permissions in relation to assets associated with the apparatus, and
a security console arranged to:
   register a control point in or for one of the logical devices in order to provide access for the control point to at least parts of the apparatus for rendering services.

According to a fifth aspect of the present invention, this object is also achieved by a computer program product for enabling differentiated control point access to services provided by a media provision entity in a computing environment having a computer networking connectivity model, comprising a computer readable medium having thereon:
computer program code means, to make the media provision entity execute, when said program is loaded in the media provision entity:
   provide at least one logical device for a media provision entity, and
   provide at least two different sets of permissions in relation to assets associated with the media provision entity from said logical device.

According to a sixth aspect of the present invention, this object is also achieved by a computer program product for providing access to a control point from a media provision entity in a computing environment having a computer networking connectivity model, which entity has at least one logica devices providing at least two different sets of permissions in relation to assets associated with the media provision entity, comprising a computer readable medium having thereon:
computer program code means, to make the media provision entity execute, when said program is loaded in the media provision entity:
   receive an access attempt from a control point in all devices and granting access according to one of the set of permissions for which the control point has received access, and
   allow access to the assets according to the permissions set.

According to a seventh aspect of the present invention, this object is furthermore achieved by a computer program element for enabling differentiated control point access to services provided by a media provision entity in a computing environment having a computer networking connectivity model, said computer program element comprising:
computer program code means, to make the media provision entity execute, when said program element is loaded in the media provision entity:
   provide at least one logical device for a media provision entity, and
   provide at least two different sets of permissions in relation to assets associated with the media provision entity from said logical device.

According to an eighth aspect of the present invention, this object is also achieved by a computer program element for providing access to a control point from a media provision entity in a computing environment having a computer networking connectivity model, which entity has at least one logical device providing at least two different sets of permissions in relation to assets associated with the media provision entity, said computer program element comprising:
computer program code means, to make the media provision entity execute, when said program element is loaded in the media provision entity:
   receive an access attempt from a control point in all devices and granting access according to one of the sets of permissions for which the control point has received access, and
   allow access to the assets according to the permissions set.

Claims 2, 14 and 18 are directed towards providing the permissions on an asset-by-asset basis.

Claims 3, 15 and 19 are directed towards providing at least two different devices, where each provides a different set of permissions.

Claims 4, 16 and 20 are directed towards allowing the same action on an asset by the two sets but provide different results from the action.

Claims 5 and 21 are directed towards using a content directory service for providing permissions.

Claims 8, 10, 11, 22, 23, 24 and 25 are directed towards ways of ensuring granting access to only one set of permissions from a control point.

The present invention has the advantage of allowing provision of different sets of permissions to control points on an asset-by-asset basis in a computing environment having a computer networking connectivity model. At the same time the connectivity model does not have to be changed. The invention is furthermore easy to implement by just providing some additional software in addition to the software already existing.

The general idea behind the invention is thus to provide at least one device for a media provision entity in a computing environment having a computer networking connectivity model. The at least one device then provides at least two different sets of permissions for control points in relation to assets of the media provision entity.

These and other aspects of the invention will be apparent from and elucidated with reference to the embodiments described hereinafter.

The present invention will now be explained in more detail in relation to the enclosed drawings, where

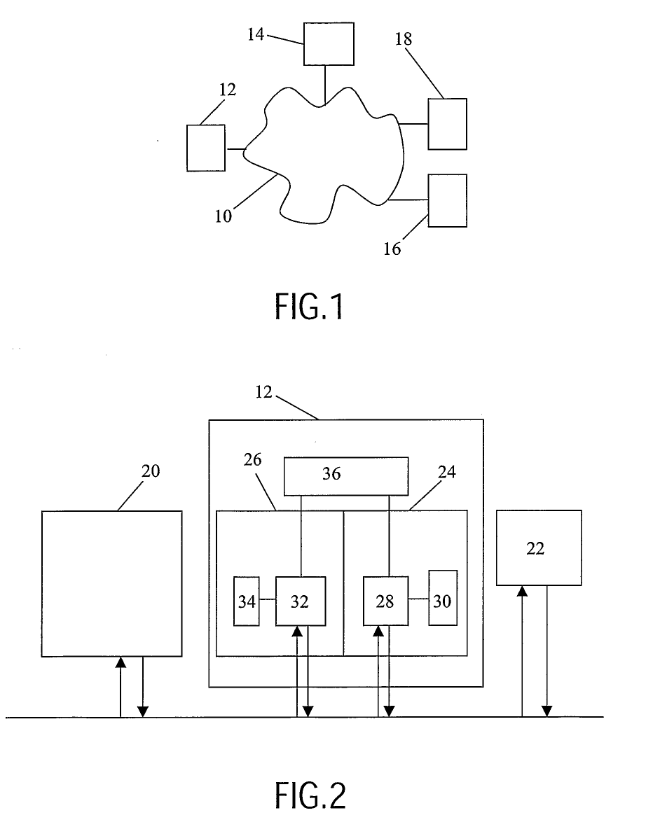

FIG. 1 shows a block schematic of a number of physical entities connected in a network,

FIG. 2 shows a block schematic of a control point, a device and a security console connected to each other,

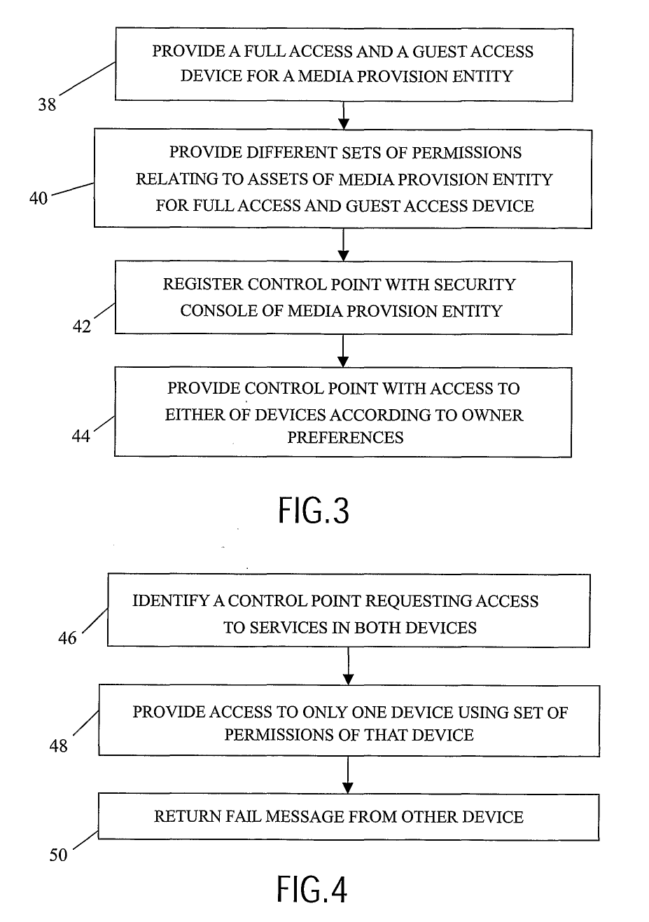

FIG. 3 shows a flow chart of a method of enabling differentiated control point access to services of a media provision entity according to a first embodiment of the invention,

FIG. 4 shows a flow chart of a method of providing access to a control point from a media provision entity according to the first embodiment of the invention,

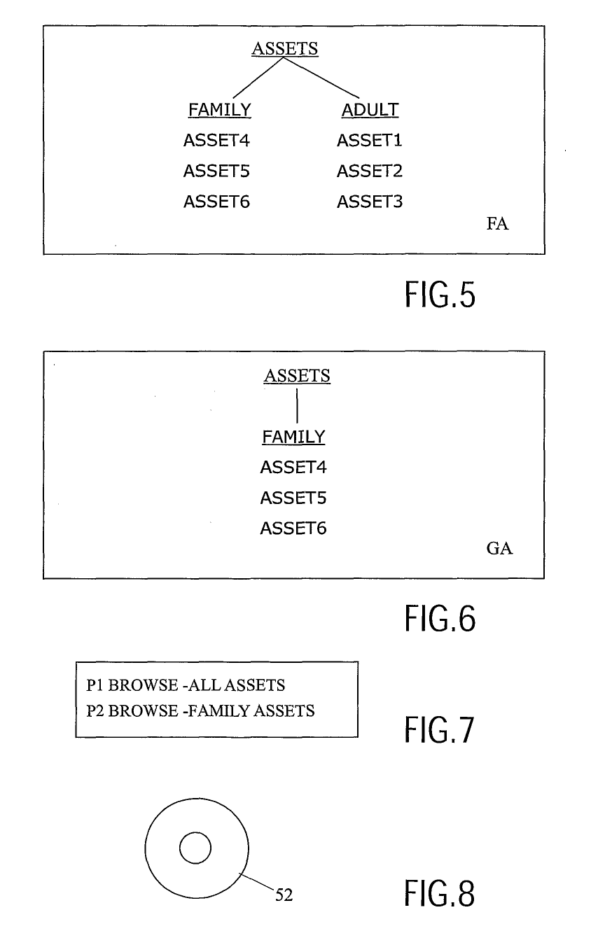

FIG. 5 shows a listing of the assets for a media provision entity according to a full access device,

FIG. 6 shows a listing of the assets for a media provision entity according to a guest access device, and

FIG. 7 shows a schematic view of permissions set in relation to one action for providing different sets of permissions according to a second embodiment of the present invention,

FIG. 8 shows a computer readable medium in the form of a CD ROM disc for storing of program code for performing the invention.

FIG. 1 shows a schematic drawing of a computer network 10, where the invention can be provided. The network 10 is in one embodiment a home network, in which different services can be provided. Because of this the network 10 includes a number of physical entities 12, 14, 16 and 18, of which at least some are media provision entities and provide different services, like for instance MP3 player, web radio, DVD player etc. Computer networking is enabled by the connectivity model or standard UPnP (Universal Plug and Play) and access to different devices is enabled through the security definitions of that standard. The network is here fixed, but it is equally as well possible that it is wireless.

The different entities in the network of FIG. 1 all have different services they provide like playing of MP3 files, providing Web radio, video, DVD or other types of media services. It is however possible that one entity can provide several types of services. The different services provided are furthermore controlled by using the standard UPnP (Universal Plug and Play).

FIG. 2 schematically shows the general functioning of UPnP in relation to a media provision entity 12 according to a first embodiment of the invention. FIG. 2 therefore shows a block schematic of different functional entities, which communicate in an UPnP system, where a control point 20 is communicating with the media provision entity 12 having a first and a second device 24 and 26, where the first device 24 is a full access device and the second device 26 is a guest access device. The details about these devices will be described later on. Each device 24 and 26 has an action control unit 28, 32 including a CDS (Content Directory Service) and an action control list 30, 34 connected to the action control unit 28, 32. Both the action control units 28, 32 are in turn connected to an asset pool 36 including all the assets of the media provision entity 12. These assets can typically be a number of MP3 files or other types of media files. Also a security console 22 is included in the figure. The control point 20, security console 22 and the media provision entity 12 can and are communicating with each other. It should furthermore be realized that these entities can be provided in one and same physical entity, but they can just as well be provided in different physical entities. A device, for instance the first device 24 has, according to UPnP, a number of services it provides. The control point 20 in the system can then try to access these services provided by the device 24. However the device 24 only grants access to a control point in dependence of settings made in relation to that control point in the action control list (ACL) 30. The security console 22, which can be seen as the owner of the device, has made these settings. In order for the control point 20 to get access to the functionalities of the device 24, it has to register with the security console 22. The security console 22 is controlled by the owner of the device, which can be the owner of the whole network. When the control point 20 therefore wants to access the device 24, it first registers with the security console 22, which then registers the rights granted to the control point in an ACL 30 of the device 24 in question. Thereafter the control point 30 can control the device 24 according to the settings made in the ACL 30. In this way security is provided in the system in that a control point can only access the services for which the security console has granted rights. Here it should be realized that both the devices 24 and 26 are provided in one of the entities for instance a first entity 12, whereas the control point 20 can be provided in the same entity or in another of the entities. Similarly the security console 22 can be provided in the same entity, but it can also be provided in another of the entities. The security console 22 can furthermore set up the different rights for several devices.

In UPnP security there exists the possibility to provide different types of accessing of a device for different control points. Here there are two facilities to present such rights. Reading/writing rights can be specified using mechanisms specified in the UPnP CDS. However, these mechanisms are then common to all control points, as the CDS has no notion of control point identity. A second facility is offered by the UPnP security mechanism, where access to UPnP CDS functions can be limited according to the individual permissions of control points. However, this access control mechanism is then common for all assets that are offered by the UPnP CDS, as all assets are accessed through the same set of CDS actions. Control points can thereby receive full and guest access control for devices and services. This access control is however general in nature and is not provided on an asset level or an asset-by asset basis. The owner of assets might want to provide different sets of permissions on the asset level to different control points. For instance some control points might not even be allowed to see a certain asset and of course not read/play that asset, while another control point associated with the owner of the asset would be allowed full access to the asset in question and also full access to all other assets of the media provision entity. There is thus a need for providing different sets of permissions to control points that enable access on an asset-by asset basis.

In order to solve this, the present invention proposes to provide at least two sets of permissions linked to the media provision entity having a common pool of assets.

How this can be done according to a first aspect of the present invention will now be described in relation to FIGS. 1, 2, 3, 5 and 6, where FIG. 3 shows a flow chart of a method of giving control points access to services provided by a media provision entity, FIG. 5 shows a view of assets for a first device using a CDS and FIG. 6 shows a view of assets for a second device using a CDS.

A media provision entity 12 or apparatus for enabling differentiated control point access to services in the home network has a number of assets, where the full number of assets is shown in a list in FIG. 5. The assets can be video clips, but it should be realized that the invention is not limited to these but can be applied on any types of assets, like MP3 files, still pictures etc. The assets of the device are presented in a hierarchy of content items and have been divided into two groups, family and adult, where the family assets are asset4, asset5, and asset6 and can be family movies, children's programs, nature films etc. A second group of assets adult include asset1, asset2, and asset3, which can include adult film material or perhaps clips with a lot of violence. The owner of the assets would then want some control points to get access to the family assets, but other control points get access to all the assets, i.e. also including the adult assets. Therefore two logical devices are provided in the physical entity 12, a full access device 24 and a guest access device 26, step 38. To the first device 24 is provided a first set of permissions in the form of full access to all assets, while the second device 26 is provided with a second set of permissions or restricted or guest access to only some of the assets, which are shown in FIG. 6 and in this case are asset4, asset5 and asset6. All the assets here belong to a pool of assets 36 and are owned by a user of the device. Thus two different sets of permissions related to the pool of assets are provided for the full and guest access device, step 40. A control point 20 then registers with the security console 22, step 42, and gets either the full or guest access according to owner preferences, step 44. The security console 22 thus sets either the full access or the guest access to a control point 20 by appropriate setting in the ACL of the device in question. Here the security console 22 can provide different types of permission on a higher level, such as only reading rights for a control point.

Now a method of accessing assets from the media provision entity 12 will be described with reference also being made FIG. 4, which shows a flow chart of this method. As mentioned before a control point 20 registers with the security console 22 of the media provision entity 12. As mentioned before, this security console 22 can be provided in the entity 12 or in another of the entities of the network. Also the control point can be provided in the entity 12, in which case it would normally be registered in the full access device 24, but it can also be a control point in any of the other entities of the network. The security console 22 then has the control point receive access right in one of the devices and not the other. In the media provision entity there is then first identified a control point 20 requesting access from the devices, step 46. If the control point has received full access, the action control unit 28 of the full access device 24 looks in the action control list 30 and identifies the settings made by the security console 22 and provides full access to the assets. This means that the CDS in the action control unit 28 allows browsing of all assets shown in FIG. 5, where the determination of what assets are allowed to be browsed is determined by the device itself, whereas the general browsing ability is granted by the security console 22. At the same time the action control unit 32 of the guest access device 26 sees that there are no settings for the control point 20 in the action control list 34 and therefore returns a fail message to the control point 20. If the control point has received guest access, the action control unit 32 of the guest access device 26 looks in the action control list 34 and identifies the settings made by the security console and provides guest access to the assets. This means that the CDS in the action control unit 32 allows browsing of only some of the assets, as shown in FIG. 6, which are a subset of all the assets in the pool of assets 36. The limitation of what assets to browse is determined by the device itself, whereas the general browsing ability is allowed by the security console 22. At the same time the action control unit 28 of the full access device 24 sees that there are no settings for the control point 20 in the action control list 30 and therefore returns a fail message to the control point 20. Therefore access to only one device is provided using the set of permissions of that device, step 48, and the other device returns a fail message, step 50.

In this way access permissions are granted on an asset-by-asset basis. There is furthermore no risk that a control point can access both devices, since the security console excludes one of the devices from being accessed.

It should be understood that the permissions for a device are not limited to browsing. They can also include other actions, like reading, writing, up-loading and searching.

According to a second embodiment of the present invention, different sets of permissions are provided in another way. In this embodiment there is only one device in the media provision entity. For each action allowed for a control point, there are a number of allowed results. The device is then provided with a number of permissions corresponding to the number of allowed results. The security console then sets one of the permissions for a control point regarding a certain action. When the control point thereafter accesses the device and attempts the action in question, the action control unit looks in the ACL and finds the set permission and performs the action according to the limitations set. An example will now be given in relation to FIG. 7, which schematically shows a first and a second permission P1 and P2 for the action browse. The first permission P1 allows browsing of all assets shown in FIG. 5, while permission P2 allows browsing of only the family assets shown in FIG. 6. The permission P1 can then be set for providing full access and the permission P2 for limited access. For a control point, where the ACL of the device has permission P1 set, the browsing action would show all the assets shown in FIG. 5 to the control point, whereas for a control point, where the ACL of the device has permission P2 set, only the limited number of assets are shown for the control point. The control point is however not aware of any limitations set. Naturally it is possible to have more different permissions for the same action. The principle described here can furthermore be applied on more actions than browsing.

One variation of the invention is that a control point can be allowed access to more than one set of permissions. In this case the media provision entity will have to exclude access trials from a control point to one of the sets and allow access trials to the other set. If one of the sets provides full access and the other provides guest access, the media provision entity would then normally allow full access and return a fail message from the set providing guest access, such that the set granting the highest degree of access gets to be dominating. It is also possible that the access is based on an or—or an exclusive-or operation on the two sets of granted permissions in case the two sets of permissions provide two different types of guest permission. It is furthermore possible that there are more different devices present in the media provision entity and thus more different sets of permissions.

The devices and security console are preferably each provided in the form of one or more processors together with corresponding program memory for containing the program code for performing the methods according to the invention. The program code can also be provided on a computer program product, of which one is shown in FIG. 8 in the form of a CD ROM disc 52. This is just an example and various other types of computer program products are just as well feasible. The program code can furthermore be downloaded to an entity from a server, perhaps via the Internet.

In the above-described embodiments of the present invention rights were granted to a control point by entries in an ACL list of a device. It is just as well possible to provide these rights in the form of a ticket, which is sent to the control point and stored there. When accessing a device, the control point then presents this ticket to the device instead of the device reading the ACL list.

The present invention thus provides more than one device in a media provision entity. In this way it is possible to provide different sets of permissions to control points on an asset-by-asset basis and without confusing control points. It is furthermore implemented with small additional costs and efforts without having to change the UPnP standard.

The invention is thus only to be limited by the following claims.

1. Method of enabling differentiated control point access to services provided by a media provision entity in a computing environment (10) having a computer networking connectivity model, comprising the steps of:
providing at least one logical device (24, 26) for a media provision entity (12), (step 38), and
providing at least two different sets of permissions in relation to assets (asset1, asset2, asset3, asset4, asset5, asset6) associated with the media provision entity from said logical device, (step 40).

2. Method according to claim 1, wherein the sets provide different permissions on an asset-by-asset basis.

3. Method according to claim 1, wherein at least two logical devices are provided and a separate set of permissions is provided for each device.

4. Method according to claim 1, wherein at least two different sets allow at least one and the same action on an asset, but provide different results.

5. Method according to claim 1, wherein the step of providing different sets of permissions is provided via a content directory service provided in each logical device.

6. Method according to claim 1, further comprising the steps of registering a control point (20) with a security console (22) associated with the media provision entity (12), (step 42), and providing the control point with access according to at least one (24; 26) of the sets of permission.

7. Method according to claim 6, wherein the control point is provided with access according to only one of the sets of permission.

8. Method according to claim 6, wherein there are at least two logical devices provided and a separate set of permissions is provided for each device and further comprising the step of attempting accessing all devices from the control point, (step 46), allowing access from one of the devices according to the set of permissions of that device, (step 48), and returning a fail message to the control point from the other devices, (step 50).

9. Method according to claim 6, wherein the control point is provided with access to both the sets of permission.

10. Method according to claim 9, further comprising the step of only allowing access for the set of permissions that are the most extensive.

11. Method according to claim 9, further comprising the step of allowing access based on a logical “or” or “exclusive-or” operation of the sets of permissions.

12. Method according to claim 1, wherein the computer networking connectivity model is UPnP.

13. Method of providing access to a control point (20) from a media provision entity (12) in a computing environment (10) having a computer networking connectivity model, which entity has at least one logical device (24, 26) providing at least two different sets of permissions in relation to assets (asset1, asset2, asset3, asset4, asset5, asset6) associated with the media provision entity comprising the steps of:
receiving an access attempt from a control point in all devices, (step 46),
granting access according to one of the sets of permissions for which the control point has received access, (step 48), and
allowing access to the assets according to the permissions set, (step 50).

14. Method according to claim 13, wherein the sets provide different permissions on an asset-by-asset basis.

15. Method according to claim 13, wherein there are at least two logical devices, where a different set of permissions are associated with each device and the step of allowing access comprises allowing access to the device associated with the set of permissions for which access has been granted.

16. Method according to claim 13, wherein at least two different sets allow at least one and the same action on an asset, but provide different results.

17. Apparatus (12) for enabling differentiated control point access to services provided in a computing environment (10) having a computer networking connectivity model and comprising:
a number of assets (asset1, asset2, asset3, asset4, asset5, asset6), and
at least one logical device (24, 26) providing at least two different sets of permissions to control points in relation to assets associated with the apparatus.

18. Apparatus according to claim 17, wherein the sets provide different permissions on an asset-by-asset basis.

19. Apparatus according to claim 17, wherein the apparatus comprises at least two logical devices where each provides a different set of permissions.

20. Apparatus according to claim 17, wherein at least two different sets allows the same action on an asset, but provide different results.

21. Apparatus according to claim 17, wherein each device is provided with a content directory service (28, 32) for identifying assets which can be accessed.

22. Apparatus according to claim 19, wherein a device for which a control point has been provided access is arranged to allow access and the other devices are arranged to return a fail message upon a request for access by the control point.

23. Apparatus according to claim 17, wherein a control point has been allowed access according to more than one of the sets of permissions and the apparatus is arranged to allow access based on a logical operation of the access rights of the different sets.

24. Apparatus according to claim 23, wherein the apparatus is arranged to allow access only to the sets of permissions that are the most extensive.

25. Apparatus according to claim 23, wherein the apparatus is arranged to allow access based on a logical “or” or “exclusive-or” operation on the sets of permissions.

26. Apparatus according to claim 17, further comprising a security console (22) arranged to allow registration of control points and provide access to the logical devices.

27. Network of computing apparatuses (10) using a computer networking connectivity model and comprising:
at least one control point (20) provided in or for one of the apparatuses of the network,
an apparatus (12) for enabling differentiated control point access to services and comprising:
at least one logical device (24, 26) providing at least two different sets of permissions in relation to assets (asset1, asset2, asset3, asset4, asset5, asset6) associated with the apparatus, and
a security console (22) arranged to:
register a control point in or for one of the logical devices in order to provide access for the control point to at least parts of the apparatus for rendering services.

28. Computer program product (52) for enabling differentiated control point access to services provided by a media provision entity in a computing environment having a computer networking connectivity model, comprising a computer readable medium having thereon:
computer program code means, to make the media provision entity execute, when said program is loaded in the media provision entity:
provide at least one logical device for a media provision entity, and
provide at least two different sets of permissions in relation to assets associated with the media provision entity from said logical device.

29. Computer program product (52) for providing access to a control point from a media provision entity in a computing environment having a computer networking connectivity model, which entity has at least one logical device providing at least two different sets of permissions in relation to assets associated with the media provision entity, comprising a computer readable medium having thereon:
computer program code means, to make the media provision entity execute, when said program is loaded in the media provision entity:
receive an access attempt from a control point in all devices and granting access according to one of the sets of permissions for which the control point has received access, and
allow access to the assets according to the permissions set.

30. Computer program element for enabling differentiated control point access to services provided by a media provision entity in a computing environment having a computer networking connectivity model, said computer program element comprising:
computer program code means, to make the media provision entity execute, when said program element is loaded in the media provision entity:
provide at least one logical device for a media provision entity, and
provide at least two different sets of permissions in relation to assets associated with the media provision entity from said logical device.

31. Computer program element for providing access to a control point from a media provision entity in a computing environment having a computer networking connectivity model, which entity has at least one logical device providing at least two different sets of permissions in relation to assets associated with the media provision entity, said computer program element comprising:
computer program code means, to make the media provision entity execute, when said program element is loaded in the media provision entity:
receive an access attempt from a control point in all devices and granting access according to one of the set of permissions for which the control point has received access, and
allow access to the assets according to the permissions set.
